(19) United States
(12) Patent Application Publication
(10) Pub. No.: US 2026/0320662 A1
(43) Pub. Date: Oct. 15, 2026

(54) BUY AND SELL APPARATUS, METHOD AND SYSTEM THEREOF

(71) Applicant: Jane Barton, Mission Viejo, CA (US)

(72) Inventor: Jane Barton, Mission Viejo, CA (US)

(21) Appl. No.: 19/570,082

(22) Filed: Mar. 17, 2026

Related U.S. Application Data
(60) Provisional application No. 63/772,809, filed on Mar. 17, 2025.

(51) Int. Cl. G06Q 30/0601; G06Q 30/0283

(52) U.S. Cl. CPC G06Q 30/0627; G06Q 30/0283; G06Q 30/0629

(57) ABSTRACT

A system, method, and non-transitory computer-readable medium for buying, selling, and trading rare, hard-to-find, or discontinued items and supplies. The system provides a mobile application interface comprising buy and sell modules, a multi-source deep search aggregator that conducts searches across retailer APIs, backstock and inventory databases, public databases, social mentions, newsfeeds, auction platforms, and third-party data sources. Search results are displayed with color-coded status indicators (available, out of stock, discontinued, or not for sale) alongside a computed Rarity Index score derived from weighted metrics including active listings count, want post frequency, historical sales velocity, discontinuation signals, and provenance verification bonus. The system can include AI image recognition and code scanning for item identification, blockchain-based provenance verification with NFT minting and smart contract royalties.

### CROSS-REFERENCE TO RELATED APPLICATION

This application claims priority to U.S. Provisional Patent Application No. 63/772,809 filed 17 Mar. 2025, to the above-named inventors, and is herein incorporated by reference in its entirety.

### FIELD OF THE INVENTION

The invention relates generally to a buy and sell apparatus, method, and system thereof. More particularly, the invention relates to a buy and sell system focused on rare, hard-to-find, or discontinued items and supplies.

### BACKGROUND

Currently there are a number of solutions for buying, selling, and trading rare goods. One of these solutions attempts to utilize an online shopping platform such as eBay, Etsy, Marketplace, etc., but this solution fails to meet the needs of the market because it can be hard to navigate and communicate with buyers and sellers.

It would be advantageous to have an improved apparatus, method and system that can make buying, selling, and trading rare goods easier. Furthermore, it would also be advantageous to have an apparatus that allows the user to communicate with buyers and sellers in an effective way. The apparatus of the present disclosure can fulfill an unmet need by providing a rare goods buy and sell apparatus, method and system.

### BRIEF SUMMARY OF THE INVENTION

In one aspect, a buy and sell apparatus, method and system of the present disclosure can include a buy, sell, and trade module with a focus on rare, hard-to-find, or discontinued items and supplies. Buyers may utilize the module's unique search tools that help locate items from a myriad of search engines, retailers, backstock, listings, and data sources to instantly alert when the goods become available. Sellers may also utilize the system to find buyers for their uncommon, rare, or antiquated items. The system may promote sustainable benefits by prioritizing or highlighting eco-friendly items (e.g., recycled, vintage, or low-waste sources) in search results, rarity scoring, and notifications, supporting a circular economy for rare goods.

In another aspect, the present disclosure can relate to a buy and sell apparatus, method and system for rare, hard-to-find, or discontinued items and supplies. The system comprises a buy, sell, and trade module with multi-source deep search aggregation (APIs, databases, real-time feeds beyond scraping), AI image recognition and code/barcode scanning, status-based actions, community bulletins for “Want” posts, niche groups, rarity scoring with provenance (including blockchain/NFT verification), predictive alerts, green/sustainability prioritization, and in-app balance for premium features and royalties. Saved items link to external sources (e.g., auctions) with calendar syncing and reminder.

In another aspect, the present disclosure is related to a computer-implemented method for computing a rarity metric for a physical item, the method comprising receiving, at a computing device, an item query comprising at least one of a text input, an uploaded image, or code data extracted from a scanned code; extracting, via an AI/ML module, item attributes from the item query, the item attributes comprising at least an item model, an item condition, and an item category; querying, via a search aggregator, a plurality of heterogeneous external data sources to retrieve data signals comprising at least an active listings count, a want post frequency, a historical sales velocity, and a discontinuation factor for the item. The method can include determining, via a blockchain integration module, a provenance verification status of the item by querying a blockchain ledger for a cryptographic hash matching the extracted item attributes. A Rarity Index score can be generated using a weighted aggregation formula incorporating the active listings count, the want post frequency, the historical sales velocity, the discontinuation factor, and a provenance bonus derived from the provenance verification status, wherein weights in the formula are tuned by a machine learning model trained on historical item data; and outputting the computed Rarity Index score for display in a user interface alongside the item.

In another aspect, the present disclosure relates to a system for automated bidirectional matching of buyer demand with seller supply for rare items, comprising at least one processor and at least one memory storing instructions that, when executed by the at least one processor, cause the system to maintain a database comprising a Want posts table storing buyer Want post records and a listings table storing seller listing records. A buyer can generate a new Want post and communicating the post via a query to a listings table and search aggregator module results for listings matching the Want post criteria. The system can compute a match score for each candidate listing based on attribute similarity and a computed Rarity Index score, and transmit a notification to the buyer identifying matching listings; upon creation of a new seller listing, query the Want posts table for Want posts matching the new listing, compute a match score for each matching Want post based on attribute similarity and a group boost factor, and transmit a notification to both the seller and matching buyers. The system can prioritize matches from niche user groups joined by the buyer or seller via a group boost toggle.

In yet another aspect, the present disclosure relates to a system for blockchain-verified provenance tracking in a rare goods marketplace, comprising at least one processor and at least one memory storing instructions that, when executed by the at least one processor, cause the system to receive item information from a seller comprising at least one of images, documents, or serial numbers. The system can extract item attributes via an AI module and generate a cryptographic hash of the extracted attributes and deploy a smart contract on a blockchain network to mint a non-fungible token storing the cryptographic hash and associated metadata, with supporting media stored on a decentralized file system; verify provenance of the item by querying the blockchain ledger for a matching hash and confirming no alterations. Upon successful verification, the system can add a provenance bonus to a computed Rarity Index score for the item and display a verified provenance badge. After a subsequent ownership transfer, the system can execute the smart contract to update the blockchain ledger, record the new ownership, and distribute an automated royalty payment to an original seller wallet address.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 is a block diagram schematically illustrating components of an exemplary system of the present disclosure.

FIG. 2 is a diagram illustrating a high-level system architecture and components of an exemplary embodiment of the system of the present disclosure.

FIG. 3 is a diagram illustrating system interactions between various modules of an exemplary embodiment of the system of the present disclosure.

FIG. 4 is a flowchart showing a Selling and Bulletin Posting Architecture of an exemplary embodiment of the system of the present disclosure.

FIG. 5 is a flowchart of a Rarity Scoring Algorithm of an exemplary embodiment of the system of the present disclosure.

FIG. 6 is a flowchart of a Blockchain Provenance Verification of an exemplary embodiment of the system of the present disclosure.

FIG. 7 is a flowchart of a Code Scanning Integration of an exemplary embodiment of the system of the present disclosure.

FIG. 8 is an illustration of an exemplary embodiment of the mobile application Search Page of the present disclosure for a quick search or photo search without needing to fully enter the app.

FIG. 9A is an illustration of an exemplary embodiment of the mobile application landing page of the present disclosure upon opening.

FIG. 9B is an illustration of a mobile application advanced search page of an exemplary embodiment of the application of the present disclosure.

FIG. 10 is an illustration of a photo recognition search page of an exemplary embodiment of the mobile application of the present disclosure.

FIG. 11A is an illustration of a search results page of an exemplary embodiment of the mobile application of the present disclosure.

FIG. 11B is an illustration of a page for detailed active listing of an item utilizing an exemplary embodiment of a system of the present disclosure.

FIG. 12A is an illustration of the mobile application detailed out of stock sell page for an item utilizing an exemplary embodiment of a system of the present disclosure.

FIG. 12B is an illustration of the mobile application detailed active sell page for an item utilizing an exemplary embodiment of a system of the present disclosure.

FIG. 13 is an illustration of an exemplary embodiment of the mobile application Data Page of the present disclosure.

FIG. 14A is an illustration of an exemplary embodiment of the mobile application Request Page of the present disclosure.

FIG. 14B is an illustration of an exemplary embodiment of the mobile application Post Community Post Page of the present disclosure.

FIG. 15 is an illustration of an exemplary embodiment of the mobile application Menu/Tools Page for a user of the present disclosure.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in numerous ways, as the subject matter is not limited to any particular manner of implementation. Examples of specific implementations and applications are provided primarily for illustrative purposes.

Before the present invention of this disclosure is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s), or step(s), to the objective(s), spirit, or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful and is not intended to exclude other embodiments from the scope of the invention.

As used herein, the term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature. Similarly, coupled can refer to a two member or elements being in communicatively coupled, wherein the two elements may be electronically, through various means, such as a metallic wire, wireless network, optical fiber, or other medium and methods.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

Referring generally to FIGS. 1-15, the system 100 of the present disclosure comprises a distributed computing architecture in which one or more client devices 200 communicate with one or more backend server systems 1000 over one or more networks 110. The system 100 may interact with other devices 200b, c and networks to communicate with potential buyers and sellers, and one or more devices 200a, b can utilize one or more processing means and wireless networks for communication and processing. One or more databases 3000 can be communicatively coupled to the devices 200. The network may include a local area network (LAN), a wide area network (WAN), the Internet, peer-to-peer networks, cellular data networks, or any combination thereof, and may employ wired or wireless transmission links, optical fibers, or other suitable communication media. The system 100 is configured to provide a mobile application interface to the client devices 200, through which users 1 access the buying, selling, searching, community bulletin, and ancillary features described herein.

A buy and sell apparatus, method and system according to the present disclosure can generally comprise a system 1000 utilizing various modules with a focus on rare, hard to find, or discontinued items and supplies. Buyers utilize the module's unique search tools that help locate items from a myriad of search engines, retailers, backstock, listings, and data sources to instantly alert when the goods become available. Sellers may also utilize the system to find buyers for their uncommon, rare, or antiquated items.

The apparatus allows a user to find and connect Buyers and Sellers of specific rare items. The disclosure contemplates third party posts associated with the desired goods and also communicates to the user status and updates on these listings. In some instances, the user may monitor posts status, interact, and communicate with the post provider.

The system also may, in some instances, have a layout or list for the desired goods and for the rare goods offered for sale. The potential seller may update the post status, communicate with the potential buyer, provide notes, get information about other desired goods, and interact regarding other listings, buyer activity history, reviews, costs, and other communication regarding the potential purchase.

The system 100 may interact with other devices and networks to communicate with the potential buyers/sellers. The devices can utilize one or more processing means and wireless networks for communication and processing. One or more databases can be communicatively coupled to the devices. Hardware may include video cameras, microphones, video players, cameras, and accessing other applications or software for communicating and transferring data to update the display output. The output may then be modified with hardware data capture information. Such as using the camera to capture video and displaying the video in real-time on the output display, including audio played over speakers. One or more modules can determine the item. In some exemplary embodiments, an artificial intelligence (AI) module can be used to identify or detect an item. In some exemplary embodiments, a system of the present disclosure can utilize a Quantum chip along with the Data centers to enable the processing of large amounts of data.

A client device 200 of the present disclosure may comprise any computing device capable of executing the mobile application 2000 and communicating with the backend server and systems over the network 110. Client devices include, but are not limited to, smartphones, tablet computers, laptop computers, desktop computers, wearable computing devices (e.g., smartwatches, headsets), personal digital assistants, set-top boxes, vehicle infotainment devices, and any other computing devices having suitable form factors and processing capabilities. Each client device 200 can include at least one processor 202, at least one memory 204 (which may include volatile memory such as RAM and non-volatile memory such as flash memory, ROM, EEPROM, or solid-state storage, communicatively coupled server), a storage device, and a bus or interconnect coupling the processor, memory, and storage device. The processor may include one or more central processing units (CPUs), graphics processing units (GPUs), digital signal processors (DSPs), or co-processors configured to execute the instructions stored in memory.

The client device can further include a display device 210, which may include a touchscreen display such as a TFT (Thin-Film-Transistor Liquid Crystal Display), an OLED (Organic Light Emitting Diode) display, an LCD (Liquid Crystal Display), or other appropriate display technology, through which the mobile application interface is rendered and through which the user provides touch-based input. A display interface comprising appropriate circuitry drives the display to present graphical and other information to the user, including the search results, listing details, Rarity Index scores, status indicators, provenance badges, and other user interface elements described herein.

A client device can further comprise one or more cameras 212 communicatively coupled to the processor. A camera can be utilized by the code scanning module to capture real-time video frames for scanning and decoding QR codes, barcodes, UPC codes, EAN codes, and serial numbers using a processing library such as ZXing, ML Kit, or AVFoundation. The camera can also be utilized by the image recognition module to capture or receive uploaded images of items for AI-based recognition, auto-tagging, and multi-source search initiation. Hardware may additionally include video cameras, microphones, video players, and speakers for communicating and transferring data, including audio played over speakers and video displayed in real-time on the output display.

The backend server systems 1000 of the present disclosure comprise one or more computing devices having similar processing devices and memory that can be configured to implement the server-side functionality of the system, including the Search Aggregator 310, the AI/ML Module 320, the Rarity Scoring Module 330, the Dynamic Pricing Module 340, the Notification Service 350, the Communication Module 360, the Blockchain Integration Module 370, the Community Bulletin Service 380, and one or more databases 390 that can be communicatively coupled. The backend server systems may be implemented as one or more standard servers, a group of servers (e.g., a server bank), a cluster of blade servers, a rack server system, a multi-processor system, or a cloud-based distributed computing system. The backend server systems may reside within a single data center at a single geographic location, or may be distributed across multiple geographic locations for redundancy, load balancing, and reduced latency. Each backend server comprises at least one processor (which may include one or more CPUs, GPUs, TPUs (Tensor Processing Units), or other specialized processors for machine learning inference), at least one memory, at least one storage device, and a communication interface coupled to the network.

The backend server systems may further include or be communicatively coupled to high-performance quantum-inspired processing hardware 4000 for processing large dataset queries received by the Search Aggregator 310 from the plurality of external data sources. The system 100 may utilize a quantum chip in conjunction with the data centers to enable the processing of large amounts of data. The backend server system(s) can host the software modules that implement the functional components of the system, including but not limited to: (a) the Search Aggregator 310, comprising the query routing module, data normalization pipeline that can remove duplicates if found, and result merge and ranking module, configured to execute multi-source deep searches across the plurality of external data sources; (b) the AI/ML Module 320, that in some exemplary embodiments include an Image Recognition Sub-Module, the Auto-Tagging Sub-Module, the Predictive Analytics Sub-Module, and the NLP Sub-Module, configured to perform image recognition, auto-tagging, predictive forecasting, and natural language processing; (c) a Rarity Scoring Module 330, configured to compute the Rarity Index score using the weighted aggregation formula with machine-learning-tuned weights; (d) the Dynamic Pricing Module 340, configured to generate pricing suggestions based on comparable items and rarity data; (e) a Blockchain Integration Module 370, configured to interface with one or more blockchain networks for NFT minting, provenance verification, smart contract execution, and royalty distribution; (f) a Notification Service 350, configured to generate and transmit predictive alerts, auction reminders, spike detection alerts, and calendar-synced notifications to client devices via push notification services, in-app inbox, or email; (g) the Communication Module 360, comprising a real-time chat engine, user inbox, and status update service for buyer-seller communication; and (h) the Community Bulletin Service 380, that can include a bidirectional matching engine, the group management module, and the bulk upload and auction import module.

The one or more databases or external sources 3000 can be communicatively coupled to the backend server systems 1000 and configured to store all persistent data used by the system. The databases can be implemented using relational database management systems, graph databases, in-memory data stores, or a combination thereof, and may utilize network-attached storage, distributed file systems, or cloud-based storage services. The database stores listings, user information, bulletins, history, alerts, groups, provenance records, saved items, scheduled auctions, and bulk imports. The database can further maintain full-text search indexes, geospatial indexes, and inverted indexes optimized for the Search Aggregator's query patterns. Decentralized storage for blockchain-related media (e.g., item images and provenance documents associated with minted NFTs) is provided via the InterPlanetary File System (IPFS) or equivalent distributed storage protocol.

The backend server systems can be communicatively coupled to a plurality of external data sources 3000 via the Search Aggregator 310 or part of the core services system 1000. External sources can include retailer APIs and websites, backstock and inventory data providers, public product databases, social media monitoring feeds, newsfeed aggregators, newsletter archives, auction platforms, and auction houses. The system communicates with each external data source via the appropriate communication protocol, which may include REST APIs, GraphQL interfaces, RSS and Atom feed parsers or any other suitable protocol, web scraping via headless browsers, proprietary data feeds, webhook integrations, and file-based imports (e.g., CSV, XML). The system can further interface with one or more blockchain networks (e.g., Ethereum) for provenance verification and NFT operations, and with third-party push notification services (e.g., Apple Push Notification Service (APNs), Firebase Cloud Messaging (FCM)) for delivering alerts and notifications to client devices. The system may also interface with device calendar services (e.g., Apple Calendar, Google Calendar) for creating auction reminder events and availability change notifications on the client device. Other networks and other applications, such as accessing a calendar to determine availability and scheduling the service appointment. Navigation may be utilized to help with directions to where the potential purchase is to be provided.

The various functional modules of the system can include but are not limited to a Search Aggregator 310, the AI/ML Module 320, the Rarity Scoring Module 330, the Dynamic Pricing Module 340, the Notification Service Module 350, the Communication Module 360, the Blockchain Integration Module 370, and the Community Bulletin Service Module 380 can be implemented as software modules stored in the memory of the backend server systems 1000 and executable by the processors thereof. Depiction of different features as separate modules does not necessarily imply whether the modules are embodied by common or separate electronic hardware or software components. In some exemplary embodiments, multiple modules may share common computing resources, and in other implementations, individual modules may be deployed on dedicated computing devices or containerized microservices. The various components and modules can be communicatively coupled via a network 110 or other means.

A mobile application 2000 executing on the client device 200 can include a client-side software module that renders the user interface layers described herein (Home Buy/Sell tabs, Search Modes, Results and Listing Details, List Item, Sell Tab, My Community Bulletin, Groups, Profile, Wallet, Notifications, Saved Items, Bulk Upload, and Auction Import interfaces) and communicates with the backend server systems via the network using application programming interfaces (APIs). The mobile application 2000 may be implemented as a native application for one or more mobile operating systems (e.g., iOS, Android), as a web application accessible via a mobile web browser, as a hybrid application combining native and web components, or as a progressive web application. Other networks and other applications may also be accessed by the system, such as accessing a calendar to determine availability and scheduling service appointments, and navigation may be utilized to help with directions to where the potential purchase is to be provided.

The system 100 may be capable of facilitating the users to locate the desired item from community bulletins, or other types of sales platform. In certain instances, when the item is not found in these convenient platforms, the invention may process a further search including searching through third parties'data, including newsletters, news, or reality shows. In exemplary embodiments, the system may display search results with status indicators (Available/green, Out of Stock/orange, Discontinued/red, Not for Sale but Found/gray) alongside a computed Rarity Index (0-100) and provenance badges (e.g., “Verified”).

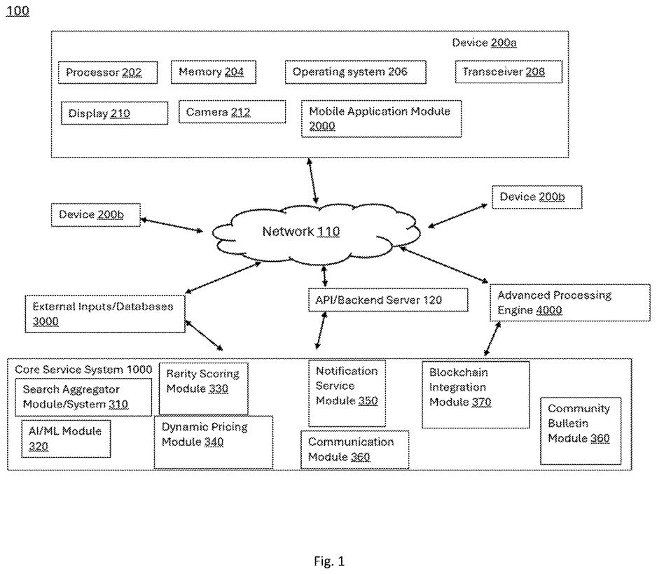

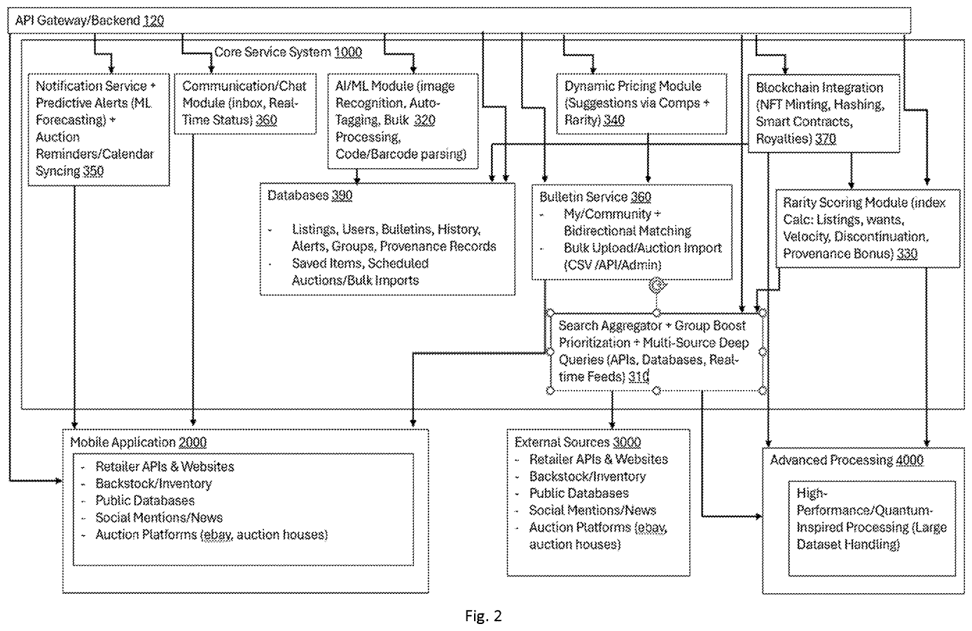

FIG. 2 is a diagram showing a system architecture of an exemplary embodiment of the system 100 of the present disclosure. The architecture can include a notification service module 350 providing predictive alerts via machine learning forecasting via an artificial intelligence and/or machine learning module, auction reminders, and calendar syncing; a communication module 360; an AI/ML Module 320 for image recognition, auto-tagging, bulk processing, and code/barcode parsing; a dynamic pricing module 340 that can provide pricing suggestions based on one or more inputs; and a blockchain integration module 370 that can analyze and provide NFT minting, hashing, smart contracts, and royalties. An exemplary embodiment of a system 100 can further include one or more databases for storing listings, user information, bulletins, history, alerts, groups, provenance records, saved items, scheduled auctions, and bulk imports. A Rarity Scoring Module 330 can generate a Rarity Index based on listings, wants, velocity, discontinuation, and provenance factor/bonus. External sources 3000 such as retailer APIs, backstock and inventory data, public databases, social mentions, newsfeeds, and auction platforms can be linked or communicatively coupled to the system. Advanced processing engine 4000 may include high-performance quantum-inspired processing for large dataset handling.

A Notification Service Module 350 can provide predictive alerts to a user or third-party (ML, forecasting), auction reminder, and calendar syncing. A Communication Module 360 may include a chat box, a user inbox, and a real-time status. The AI/ML Module 320 can include and provide image recognition, auto tagging, bulk processing, code/barcode parsing. A Dynamic Pricing Module may include suggestions via comps and rarity. The Blockchain Integration may include NFT Minting, hashing, smart contracts, royalties. The system may include a database comprising listing, users information, bulletins, history, alerts, groups, provenance records, saved items, scheduled auctions, and bulk imports. The bulletin service may comprise a Community module that can have a bidirectional matching and bulk upload, auction import (CSV/API/Admin) capabilities.

A Rarity Scoring Module 330 may include an index calculation according to the listings, wants, velocity, discontinuation, and provenance bonus of the items. A search aggregator 310 may be coupled to or include a group boost prioritization module plus multi-source deep queries (API, databases, real-time feeds). External sources 3000 may be linked to the system such as retailer APIs and websites, backstock and inventory data, public databases, social mentions, newsfeed, auction platforms, auction houses. Advanced processing may include high-performance quantum-inspired processing for large datasets handling. The mobile application may include UI layers: Home Buy/Sell tabs, Search Modes (Photo, Advanced, Scan Code), Results and Listing Details, List Item, Sell Tab, My Community Bulletin, Groups, Profile, Wallet, Notifications, Saved Items, Bulk Upload, Auction, Import (Admin/Partner).

The Rarity Scoring Module can generate a dynamic Rarity Index using weighted aggregation of one or more factors that can include active listings count across sources, frequency of matching “Want” posts in bulletins and groups, historical sales velocity, discontinuation signals from news/retailers, provenance verification (AI analysis of uploaded documents or blockchain records). The Rarity Scoring Module 330 can further comprise a feedback loop architecture in which the Rarity Scoring Module 330 outputs a computed Rarity Index score that can be simultaneously transmitted and used by the Dynamic Pricing Module 340 to generate pricing suggestions. The Notification Service 350 can use the inputs to evaluate spike detection thresholds and generate predictive alert. A Community Bulletin Service 380 can prioritize bidirectional matching of Want posts with seller listings. The result can be merged and ranked by the Search Aggregator 310 to rank search results, such that a change in any input signal to the Rarity Scoring Module 330 propagates through all consuming modules without requiring separate recalculation by each module.

A bidirectional matching engine of the present disclosure can operate in both directions simultaneously (i.e., when a buyer posts a Want for a desired item, the engine can actively search for matching seller listings across both the internal database and external aggregated sources. Similarly, when a seller posts a new listing, the engine actively searches for matching outstanding Want posts.) The matching process incorporates the computed Rarity Index score, attribute similarity, the group boost factor, and optional urgency and condition preferences specified by the buyer, producing a prioritized list of matches that can be transmitted as notifications or alerts to both parties/users. This demand-supply matching functionality operates in addition to conventional browsing and search-based discovery, creating a network effect that accelerates transaction velocity for rare items.

One exemplary algorithm for generating a Rarity Index=100−(w₁×normalized listings)+(w₂×normalized wants)−(w₃×velocity)+(w₄×discontinuation factor) +provenance bonus (between about 10-20 points for verified records in some exemplary embodiments). The algorithm can weigh various factors and can be tuned via machine learning; spikes trigger alerts. The Rarity Index can be generated and displayed in results and listings, influencing pricing and matching.

The system can provide predictive alerts for out of stock/discontinued items, “Notify when available” utilizing ML-based forecasting (e.g., time-series models analyzing historical patterns, seasonal trends, and restock signals from aggregated sources). The system can predict probabilities/timelines and sends proactive alerts to a user via a user device or other alert.

In some exemplary embodiments, the search aggregator module can include a group-powered search boost algorithm or module to provide an advanced or enhanced search that can include a group boost toggle/filter that can be selected by a user. Results prioritize listings/“Wants” from user-joined groups (e.g., “Gretsch Drummers”). Groups support polls, group buys, moderated postings, and collaborative discovery.

The system can further utilize blockchain Integration for collectibles for provenance verification, the system creates immutable digital twins via NFTs on blockchain (Ethereum +IPFS). Sellers upload docs/images/serial →AI generates hash →mints NFT/smart contract records ownership/metadata. Verification queries ledger for match/no tampering, adding bonus to Rarity Index. Smart contracts enable royalties (5-10%) on resales.

A mobile application supports code scanning (QR codes, barcodes, UPC/EAN, serial numbers) using an external camera or a camera of the client's device. This feature accelerates item identification and listing: Sellers: Tap “Scan Code”→auto-populate fields (Title, Category, Model, Price suggestion). Buyers: Scan code→trigger multi-source search, display rarity/status/actions. Provenance: Scan QR on certificates→link to blockchain verification. Technical: Camera feed→processing library (ZXing/ML Kit)→feed to Aggregator/AI.

The Search Aggregator 310 can initiate deep, multi-layered searches using structured APIs, databases, and real-time feeds for comprehensive results across retailers, backstock, historical listings, news, newsletters, social mentions, and third-party sources, exceeding surface-level scraping to enable thorough discovery of rare or discontinued items.

Saved items can retain original source URLs and can be accessed from the user profile (e.g., Saved Items section). Tapping a saved item can generate a link or automatically redirect a user to the external source (e.g., auction site, eBay listing) for purchase or attendance. In further embodiments, the Notification Service module 350 can integrate with device 200 calendars to create events and reminders for saved items, including upcoming auctions or availability changes (e.g., calendar events for scheduled auction start times). The AI/ML module can further be communicatively coupled and provide potential forecasting that can set reminders or sync with a user's calendar or device to provide an alert.

A Bulletin Service module can support and initiate bulk uploads and scheduled auction imports (e.g., via CSV, API, or admin interface) for partners such as auction houses, with AI-assisted processing and automatic posting to Community Bulletin or Active Selling. In some exemplary embodiments, the system promotes sustainable benefits by prioritizing or highlighting eco-friendly items (e.g., recycled, vintage, or low-waste sources) in search results, rarity scoring, and notifications, supporting a circular economy for rare goods.

In some exemplary embodiments, the system can generate a sustainability score for use in the Rarity Scoring Module based on one or more of the following factors: whether the item is classified as recycled, refurbished, or vintage; the estimated carbon footprint reduction associated with purchasing the item secondhand versus new. The Search Aggregator may apply a sustainability boost factor to prioritize eco-friendly items in search result rankings when a user activates a green filter toggle.

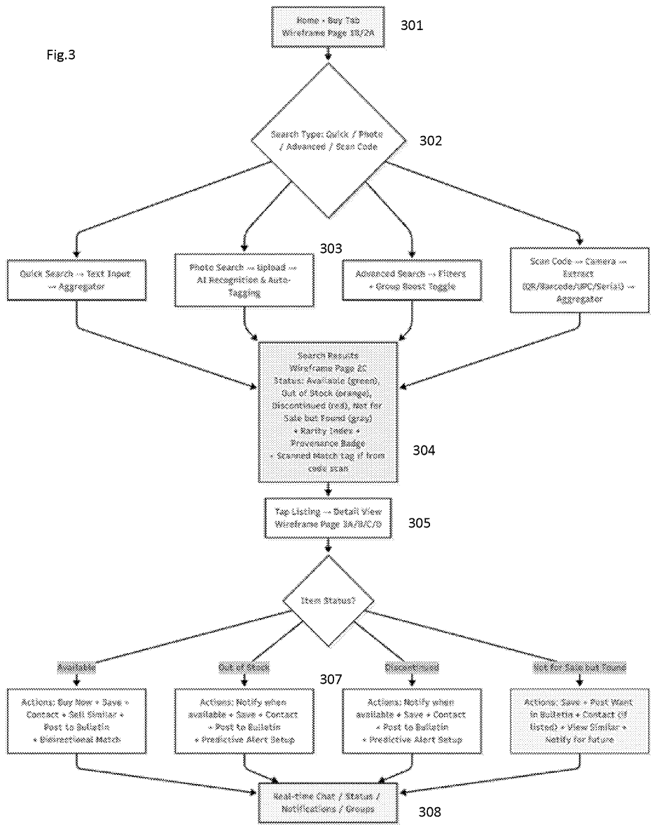

FIG. 3 illustrates a flowchart showing the Search Functionality of an exemplary embodiment of the system of the present disclosure. The flowchart depicts an exemplary process flow beginning from the Home Buy Tab for a user to enter the application (Step 301), to commence a search (Step 302) through the Search Module 310 offering multiple search modes (Step 303) (quick, photo, advanced, and scan code), to the generation and display of search results (Step 304) with status indicators, Rarity Index scores, and provenance badges. Each search mode can be communicated to and between each other and/or a search aggregator or search aggregator module. A search aggregator module 310 can conduct deep, multi-source queries and returns results that are classified by status (Available, Out of Stock, Discontinued, Not for Sale). A detailed view can be accessed (Step 305) that can provide actionable options to the user based on each item's respective status (Step 307), such as buy now, save, contact seller, notify when available, post to bulletin, and predictive alert setup. A user can then contact or communicate with the Seller (Step 308) through the application 2000.

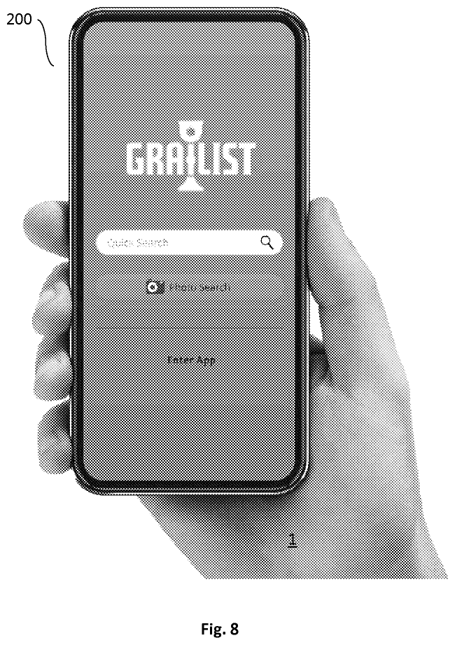

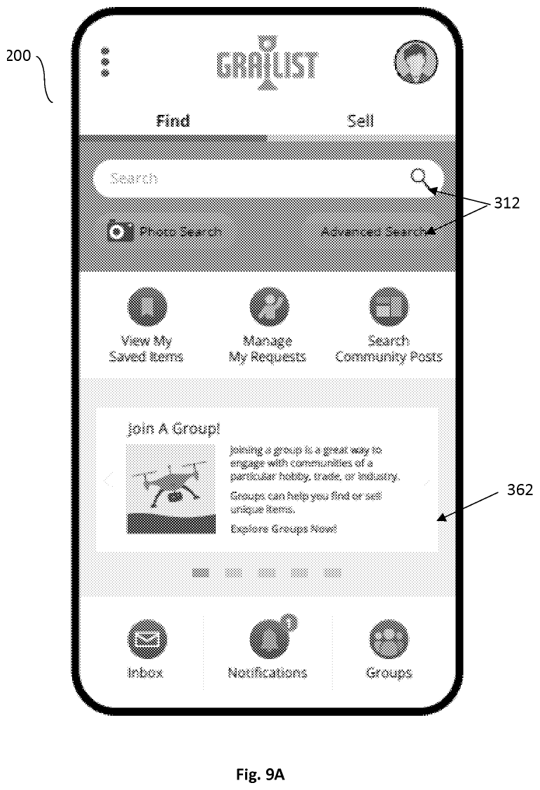

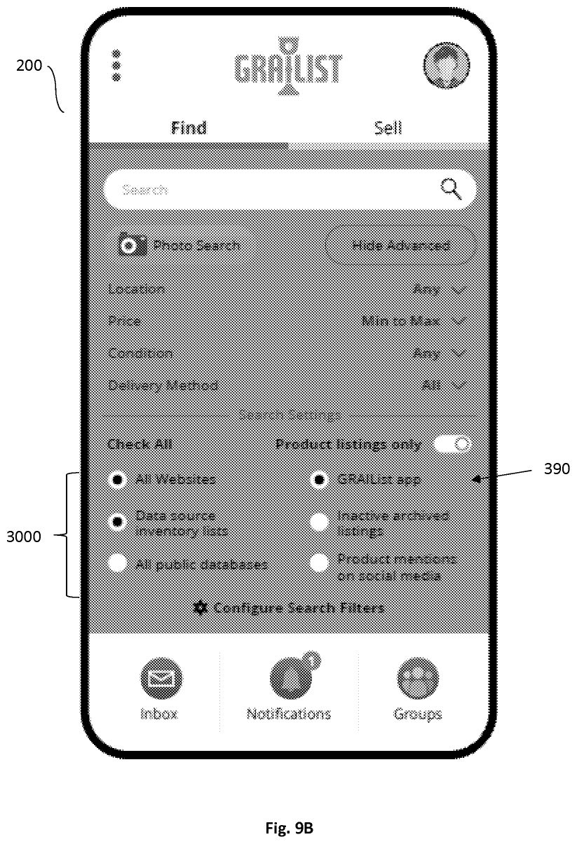

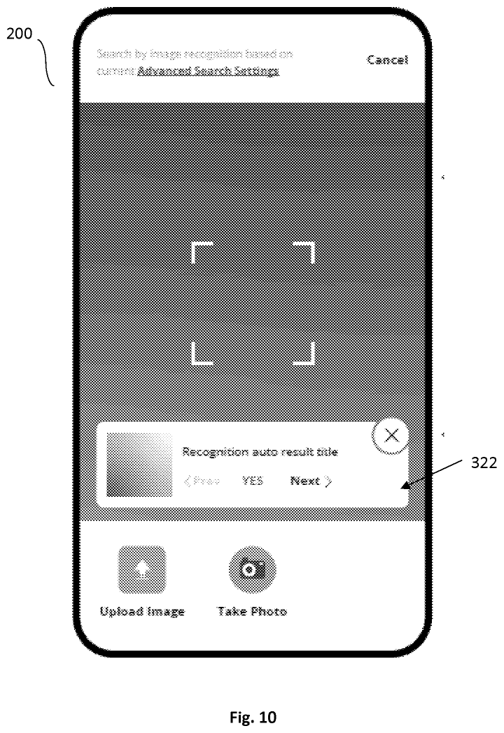

Upon an initial launch of the application 2000 an initial search page can be displayed to provide quick on the go searching feature for a user which can be displayed on the user device (FIG. 8). A Home page can include a Search Module interface having one or more types of search modes 312 including but not limited to quick, photo, advanced, scan code search (FIG. 9A). A quick search may comprise a text input module and an aggregator. Photo search may include an uploaded image, an AI recognition and auto tagging that can utilize a camera 212 or a saved image in a memory 204, database 390, or external source 3000. Advanced search may include filters and group boost toggle (FIG. 9B). This can allow a user to narrow or widen the scope of the search and generated results. This can include the data sources searched including the database 390 and external sources 3000, including but not limited to across the internet, connected data sources, posts, inactive/archived listings, or other platform listings. Scan code search may include a camera extract, such as from a QR, Barcode, UPC, or Serial Number, and an aggregator (FIG. 10).

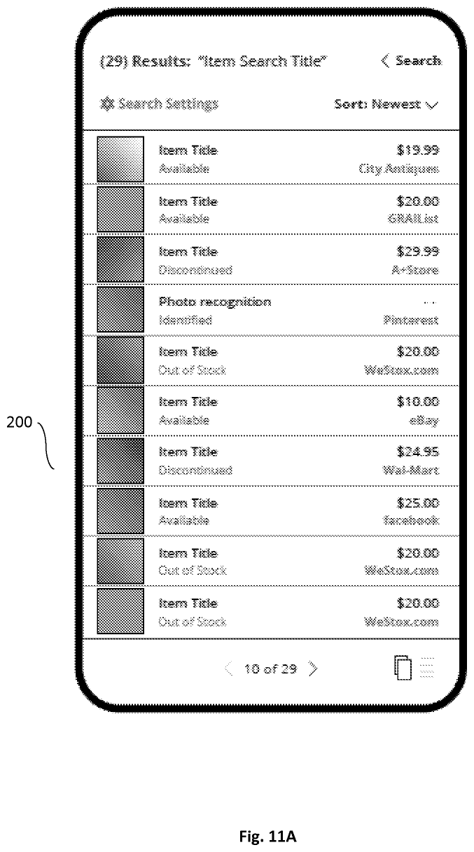

After an image is framed, the AI module 320 can initiate a pop up 322 with an instant identification of the item. A user may then accept the recognition and jump to the result or dismiss and submit a photo or image for a full list results of the captured item. Search results may include an item information such as status (available, out of stock, discontinued, not for sale), source or location of item (local, website, etc.), price, and image. The status information may further be indicated with a color code (FIG. 11A). The status information may further include rating such as a generated rarity index and/or provenance badge (Blockchain token, authenticity certification, etc.). Additional product information may be retrieved and listed such as a scanned match tag.

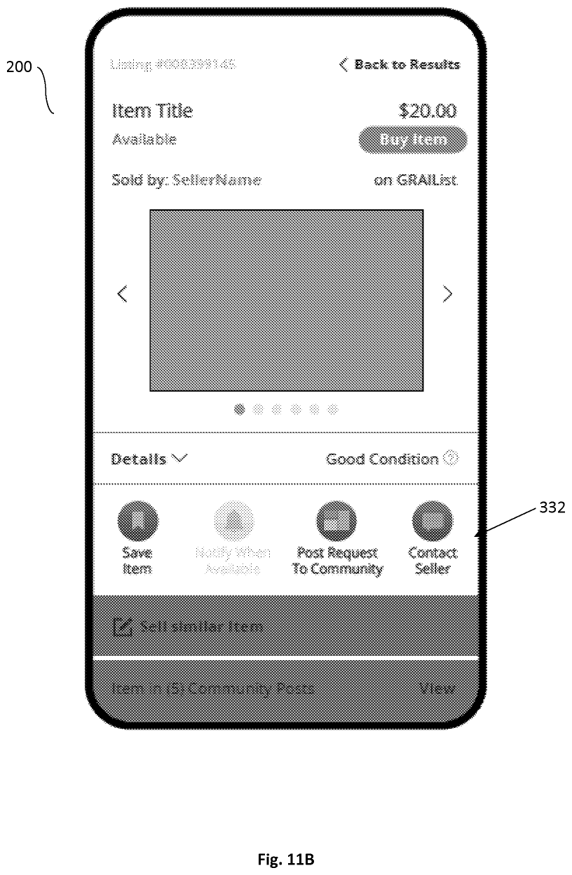

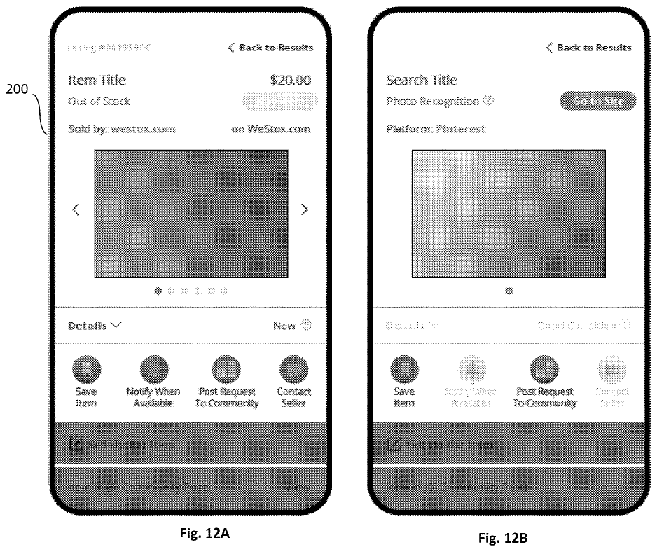

The list may further include additional information opened on a separate detailed view module (FIG. 11B). The detail view window may contain actionable input 332 from a user which may be related to each of the respective item status. Available status may include actions such as, buy now, save, contact seller, sell similar, post to bulletin, and bidirectional match. Out of stock status may include actions such as, notify when available that can be executed by the notification module 350, save, contact seller, post to bulletin through a bulletin module, and predictive alert setup (FIG. 12A). Discontinued status may include actions such as notify when available, save, contact seller, post to bulletin, and predictive alert setup. Not for sale status may include actions such as, save, post want in bulletin, contact (if listed), view similar, and notify for future. The system may further allow for real-time chat, status, notifications, and private groups. For items that are identified from an external source (website, social platform, etc.) a user can attempt to contact the owner of the source/item to inquire about information on how to order or purchase the item (FIG. 12B). A user can further be provided options over the display to sell a similar item or view any wanted listings in the community posts to contact potential buyers interested in the item to make a sale.

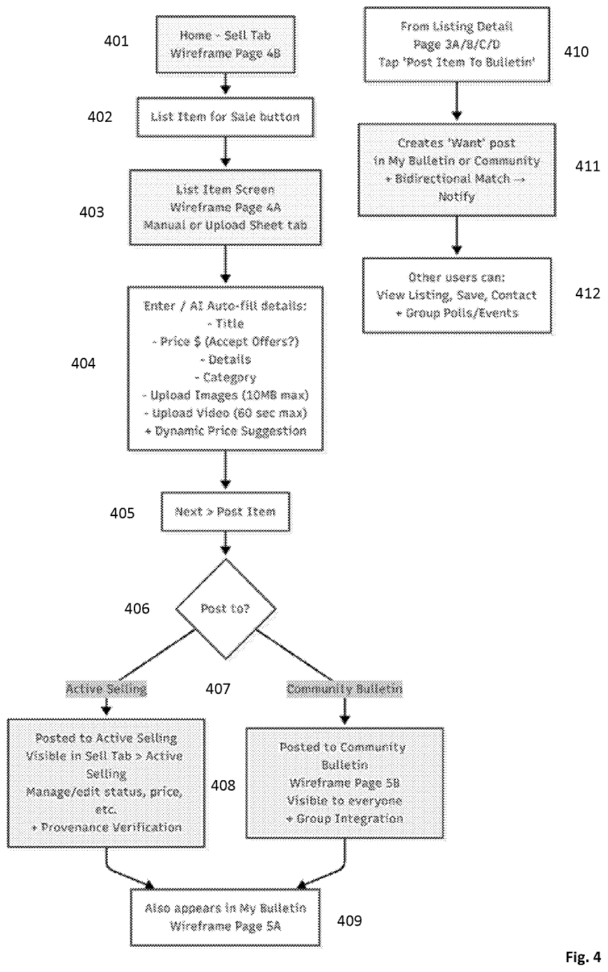

FIG. 4 illustrates a flowchart showing a selling and bulletin posting flow architecture of an exemplary embodiment of the system of the present disclosure. The flowchart depicts a user/seller's process flow from a home sell tab (Step 401) through the List Item for Sale function, where the seller may manually enter or upload item details via a sheet tab (Step 403), or utilize AI auto-fill to populate fields including title, price, optional offer acceptance, details, category, images, and video (Step 404). A dynamic price suggestion is generated by the dynamic pricing module 340 based on comparable items and rarity data. The seller then posts the item (Step 406) to either Active Selling, which is visible in the Sell Tab, or the Community Bulletin (Step 407), which is visible to all users and supports group integration. Posted items also can be generated and displayed in the seller's My Bulletin section (Step 409). The app can generate a detailed listing page that can be accessed through the system (Step 410). A user can post item to Active selling or Community Bulletin (Step 411). Active selling can be visible in sell tab while Community Bulletin is visible to everyone plus group integration (Step 412). Posted items can also appear in My Bulletin of a user/seller.

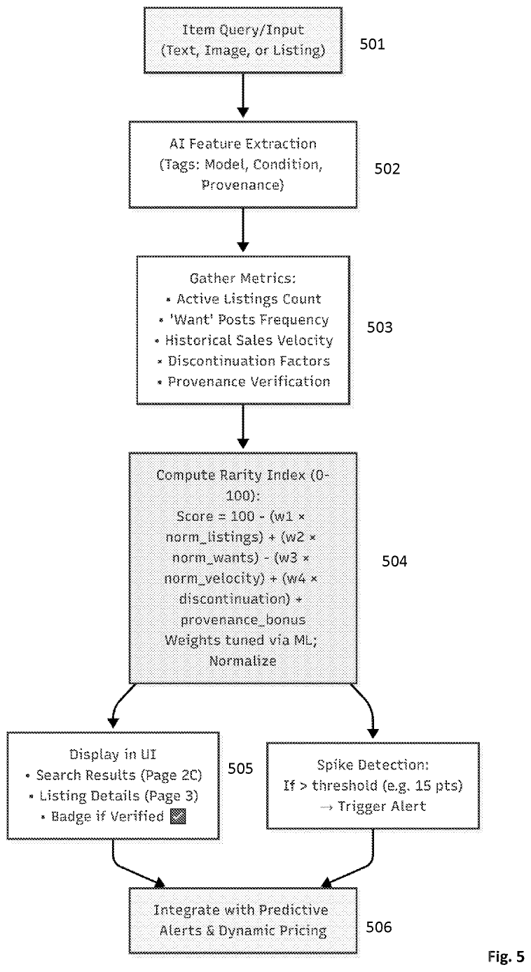

FIG. 5 illustrates a process flowchart that can be used by an exemplary embodiments of a Rarity Scoring Module 330 of the present disclosure. The process can begin with an Item Query Input (text, image, or listing) (Step 501), followed by AI feature extraction to generate tags including model, condition, and provenance (Step 502). The system can gather metrics including active listings count, “Want” post frequency, historical sales velocity, discontinuation factors, and provenance verification status through the application database as well as other external sources (Step 503). A Rarity Index score can be generated from 0 to 100 via a prescribed rarity algorithm of the module 330. In some exemplary embodiments, the algorithm can include the following: 100−[(w₁×normalized listings)+(w₂×normalized wants)−(w₃×normalized velocity)+(w₄×discontinuation factor)+(provenance bonus)], with score weights tuned via machine learning and can then be normalized. The generated score can be displayed in the UI within search results and listing details, with a badge displayed if provenance is verified. A user can set predetermined thresholds that can trigger a Spike detection which can generate an alert if a threshold change (e.g., 15 points) is reached (Step 505). The system can further integrate with predictive alerts and dynamic pricing based upon the spike detection and predictive alerts (Step 506).

In some exemplary embodiments, the machine learning model used to tune the weights of the Rarity Index formula can be retrained on a periodic or event-driven basis using a training dataset comprising historical transaction outcomes, including completed sales, abandoned transactions, time-to-sale duration, and buyer engagement metrics (e.g., save rate, notification opt-in rate). The model applies a supervised learning algorithm (e.g., gradient boosting, neural network regression) to optimize the weight values w₁ through w₄ such that the computed Rarity Index score is maximally predictive of actual transaction likelihood and price premium for rare items. The retrained weights are deployed to the Rarity Scoring Module via a model versioning pipeline, and prior weight configurations are retained for audit and rollback purposes.

In some exemplary embodiment, the Rarity Index of the present disclosure is distinguished from conventional search result scoring in that the Rarity Index is not merely a search result ranking signal but rather a persistent, item-level metric that is computed, stored in the database, continuously updated as new data arrives from the Search Aggregator, and consumed by multiple downstream modules for different purposes. The Rarity Scoring Module generates the computed Rarity Index score to the items in the database and updates the score whenever new data is received from any monitored external data source. The spike detection module monitors the stored Rarity Index scores for tracked items and generates alerts when changes exceed the configurable threshold. The Dynamic Pricing Module reads the current Rarity Index score when generating pricing suggestions, such that a seller listing a high-rarity item receives a higher suggested price. The bidirectional matching engine of the Community Bulletin Service incorporates the Rarity Index score into match score computation, such that Want posts for high-rarity items are matched with higher priority. A Predictive Analytics Sub-Module can incorporate the Rarity Index trend data into its time-series forecasting model inputs providing a cross-cutting role of the Rarity Index as a persistent, multi-consumer system metric for individual items.

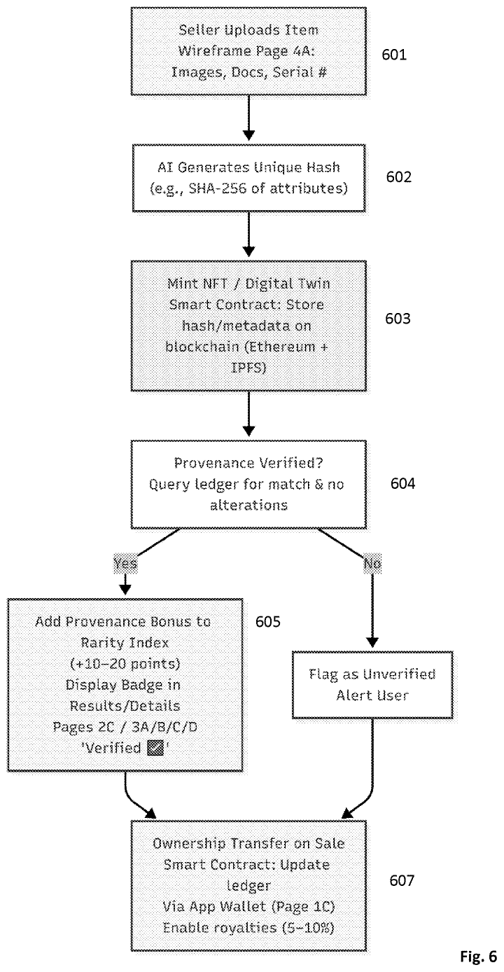

FIG. 6 illustrates an exemplary blockchain provenance verification process that can be executed by a blockchain integration module 370 of an exemplary embodiment of a system of the present disclosure. A seller can upload items in images, documents, or serial number format (Step 601). AI module can generate and output unique hash (e.g., SHA-256 of attributes) (Step 602). Mint NFT/Digital twin smart contract may include a store hash or metadata on blockchain (Ethereum +IPFS) (Step 603). An optional provenance verification may include query ledger for match and no alterations (Step 604). If YES, the system can generate and add provenance bonus to rarity index (+10-20 points), display badge in results and details tab, also add “verified”. If NO, the system can flag as unverified and provide an alert user. Ownership transfer on sale smart contract may include update ledger via the app wallet and enable royalties (about 5-10%) (Step 607).

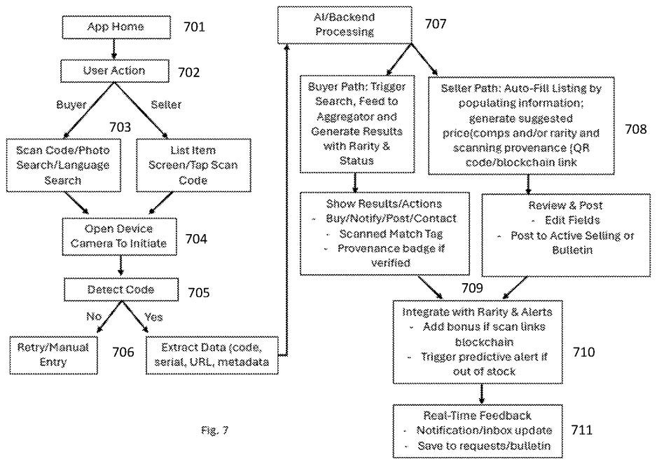

FIG. 7 provides a code scanning integration process for a user of an exemplary embodiment of a system of the present disclosure. The home or buy tab displayed on a user device may require a user action input (Step 702). User/buyer can scan to search, tap “scan code” at quick/photo search, whereas a User/seller scan to list, tap “scan code” at list item screen (Step 703). A user can then open the camera for real-time scanning (QR or barcode, UPC, or serial number)(Step 704). If a code was detected (ZXing, ML Kit, AVFoundation), extract data (code serial, URL, metadata), however, if no code was detected, retry or manual entry of data (Step 706). The system can then initiate an AI or Backend processing (Step 707) based upon the extracted/detected data. AI Backend processing of detected data for buyer can initiate a search within feed to aggregator, lists results with rarity and status, or detected data for seller triggers auto-fill listing including title, category, model, suggested price, and scan for provenance QR or blockchain link (Step 708). A Buyer user path can further show results and actions such as buy, notify, post, contact, scanned match tag, and provenance badge if verified, and a Seller user path can further show review and post, edit field, activate post, selling or bulletin option (Step 709). The system can integrate rarity indexing and alerts can be enabled for both buyers and sellers, which can generate and add bonus if scan links blockchain, trigger predictive alert if out of stock (Step 710). Real-time feedback such as notification, inbox updates, save to requests or bulletin can be generated and transmitted to a user (Step 711).

FIGS. 8-15 provide illustrations of a user device with a display and camera that can be utilized to access and/or implement a system 100 and display varying generated outputs of an exemplary embodiment of a system 100. FIG. 8 provides an initial search page for a user to identify items on the go. As shown in FIG. 9A-B, a user can enter the application home page which serves as the primary navigation interface for the system and presents the user with selectable tabs for buying and selling functionality. In an exemplary embodiment, the Home Page includes a Buy Tab and a Sell Tab, each providing access to the respective modules of the system. The Home Page may further display notifications, saved items, user profile access, wallet information, and links to the Community Bulletin and niche groups, allowing the user to navigate to all principal features of the system from a single centralized interface.

A Search Page can provide one or more search modes including a quick search, a photo search, an advanced search, and a scan code search, each designed to enable a user to locate rare, hard-to-find, or discontinued items across a plurality of data sources. The quick search mode includes a text input module coupled to a Search Aggregator that conducts deep, multi-layered searches using structured APIs, databases, and real-time feeds for comprehensive results across retailers, backstock, historical listings, news, newsletters, social mentions, and third-party sources. As shown in FIG. 9B, an advanced search mode includes filters and a group boost toggle that prioritizes listings and “Want” posts from user-joined groups. Search results are displayed with status indicators (e.g., Available/green, Out of Stock/orange, Discontinued/red, Not for Sale but Found/gray) alongside a computed Rarity Index and provenance badges.

FIG. 10 provides an illustration of an exemplary embodiment of a mobile application Image Recognition Page of the present disclosure. The Image Recognition Page can allow a user to upload an image of a desired item, whereupon an AI recognition module can analyze the image and performs auto-tagging to identify attributes such as item model, condition, category, and provenance-related features. The AI module can utilize one or more machine learning models to detect and classify the item, and the recognized attributes are fed to the Search Aggregator to trigger a multi-source deep search and return matching results with rarity scores and status indicators.

FIGS. 11A-B provide illustrations of an exemplary embodiment of the mobile application Listing Page of the present disclosure. The Listing Page displays detailed information about a specific item identified in a search result or posted for sale. The Listing Page may include the item title, category, price, images, video, a computed Rarity Index score, provenance badge (e.g., “Verified”), and status information. The page further provides actionable options to the user depending on the item's status, such as buy now, save, contact seller, sell similar, post to bulletin, notify when available, and predictive alert setup.

FIGS. 12A-B provide illustration of an exemplary embodiment of the mobile application Status Page of the present disclosure. The Status Page can display and communicates to the user the current status and updates on item listings, including whether an item is available, out of stock, discontinued, or not for sale. The Status Page may display color-coded status indicators and allow the user to monitor post status, interact, and communicate with the post provider, and receive real-time notifications and updates regarding changes in item availability, rarity index, and pricing trends.

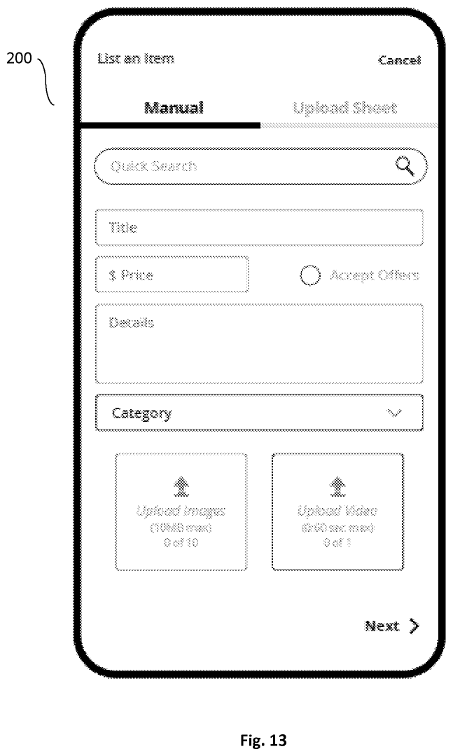

As shown in FIG. 13, a user can access a Sell Page of an exemplary embodiment of the system of the present disclosure. A Sell Page enables a user acting as a seller to list an item for sale by entering or having AI auto-fill item details including title, price, optional acceptance of offers, item details, category, uploaded images, and uploaded video. The Sell Page can further provide a dynamic price suggestion that can be generated by the dynamic pricing module which can provide generated pricing recommendations based on comparable items and the item's Rarity Index accessed by the system. A seller may post the item to Active Selling, which is visible in the Sell Tab, or to the Community Bulletin, which is visible to all users and supports group integration.

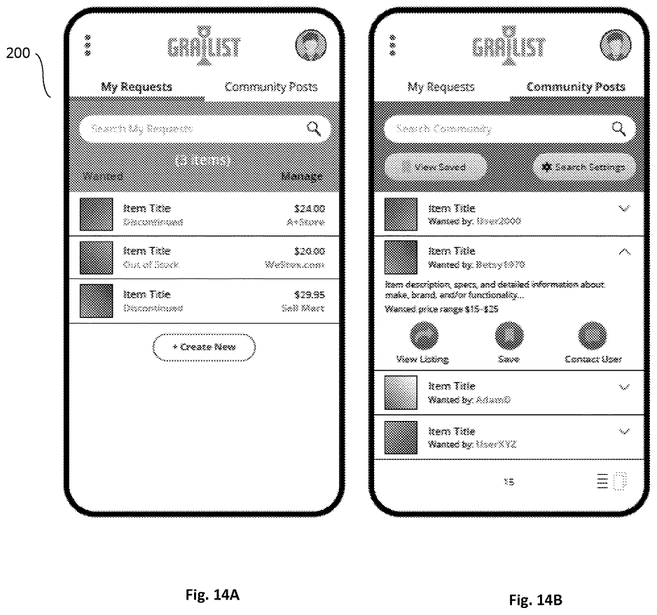

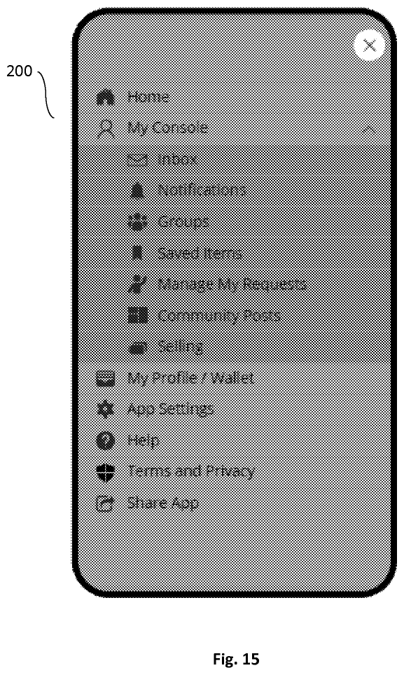

The system can generate a my request page and a community post page that can be accessed by a user via the device as shown in FIGS. 14A-B. The Post/Request Page allows a user to create and manage community bulletin postings, including “Want” posts for desired items and sale posts for items offered to the community. The page supports bidirectional matching, wherein the system matches “Want” posts from buyers with available listings from sellers and vice versa. The Community Bulletin further supports group integration, polls, group buys, moderated postings, and collaborative discovery within niche user groups. FIG. 15 provides an illustration of a menu page presenting an overview of the principal capabilities of the system, including multi-source deep search aggregation, AI image recognition and auto-tagging, code and barcode scanning, rarity scoring with provenance verification, predictive alerts, community bulletins and niche groups, dynamic pricing, blockchain and NFT integration, and green and sustainability prioritization.

An exemplary embodiment of the system of the present disclosure addresses specific technical problems in the field of computerized search and e-commerce systems. Conventional search systems, such as those described in the identified prior art, perform searches against a single data source or a limited set of sources, and return results ranked by keyword relevance or application-level scoring features. These conventional systems do not address the unique technical challenges associated with locating rare, discontinued, or hard-to-find items, where the relevant information is fragmented across data sources of varying formats and protocols, where item availability status changes frequently and unpredictably, and where conventional keyword-relevance scoring fails to capture the true significance of a search result to a user seeking a rare item.

The present disclosure provides various technical solution to these problems through (i) a Search Aggregator that implements a query routing module, data normalization pipeline, and result merge and ranking module to execute multi-source deep searches across external data sources using source-specific queries and communication protocols; (ii) a Rarity Scoring Module that computes a quantitative Rarity Index using a weighted aggregation formula with machine-learning-tuned weights, incorporating real-time data signals from multiple system modules; (iii) a blockchain provenance verification pipeline that generates cryptographic hashes, mints NFTs via smart contracts, and queries a distributed ledger to verify item authenticity, with the verification result directly modifying the Rarity Index computation; and (iv) a predictive alerts engine using time-series machine learning models that analyze aggregated data streams to forecast item availability and proactively notify users. These components work together as an integrated technical architecture that improves the functioning of the computer system itself—not merely by automating a manual commercial process, but by enabling computational operations that could not be performed by a human mind, including real-time aggregation and normalization of data from dozens of APIs, computation of a dynamic rarity metric from continuously updated multi-source signals, cryptographic hashing and blockchain ledger queries for provenance verification, and machine learning-based time-series forecasting from aggregated availability data streams.

In some exemplary embodiments, the system 100 can use a Search Aggregator with source-specific query routing feeds to normalize data to a Rarity Scoring Module that can compute a weighted index with ML-tuned weights and a provenance bonus derived from blockchain ledger verification. A generated Rarity Index can be transmitted and used by a Dynamic Pricing Module that can include a spike detection alert engine, a bidirectional community bulletin matching engine, and a predictive ML-based availability forecasting engine, all operating on continuously updated multi-source data streams. The system can further integrate blockchain provenance verification results into a quantitative scoring formula that can then be used to drive dynamic pricing, alert thresholds, and bidirectional matching represents a non-routine combination that is not well-understood or conventional in the art of computerized marketplace systems.

A system of the present disclosure can perform multiple stages of data transformation including taking data received from a plurality of external data sources in disparate formats (e.g., JSON responses from retailer APIs, HTML content from web scraping, XML feeds from auction platforms, plain text from social media monitoring, and structured database query results from inventory systems) that can then be transformed through the data normalization pipeline into a unified item record scheme to be displayed to a user device. The item records are then transformed by the Rarity Scoring Module, which computes a quantitative Rarity Index score by applying a weighted aggregation formula to five distinct input signals (active listings count, want post frequency, historical sales velocity, discontinuation factor, and provenance bonus), each of which is independently derived from aggregated multi-source data and normalized to a common scale. The computed Rarity Index score, can then be input by downstream modules (Dynamic Pricing Module, spike detection engine, bidirectional matching engine, predictive alerts engine), each of which can perform additional data transformations to generate outputs (pricing suggestions, threshold alerts, matched Want post notifications, and predictive availability forecasts) that are fundamentally different from the raw input data.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A system for locating and transacting rare, hard-to-find, or discontinued items, comprising:
at least one processor;
at least one memory coupled to the at least one processor and storing instructions that, when executed by the at least one processor, cause the system to: receive, via a mobile application interface, a search query for a desired item,
wherein the search query comprises at least one of a text input, an uploaded image, or extracted code data;
wherein the processor parses, via a query routing module of a Search Aggregator module, the search query and generate a plurality of source-specific queries, each query optimized for a respective one of a plurality of external data sources or databases, the plurality of external data sources comprising at least one or more of: retailer APIs, backstock and inventory databases, public product databases, social media monitoring feeds, news aggregator feeds, auction platform APIs, and newsletter archives;
transmit each source-specific query to the respective external data source via a corresponding communication protocol;
receive response data from the plurality of external data sources and normalize, via a data normalization pipeline of the Search Aggregator, the response data into a unified item record scheme comprising at least an item identifier, item title, availability status, source identifier, and source URL;
normalize item records using at least one matching algorithm selected from exact match on product identifiers, fuzzy text matching, and AI-based image similarity matching;
classify each item record with a status indicator selected from the group consisting of available, out of stock, discontinued, and not for sale;
compute and generate, via a Rarity Scoring Module, a Rarity Index score for each item record using a rarity algorithm using a weighted aggregation formula incorporating at least one or more weights from the following: active listings count, want post frequency, historical sales velocity, discontinuation factor, and a provenance bonus;
wherein the weights are tuned via a machine learning module;
rank, via a result merge and ranking module, the item records based on a composite score incorporating the computed Rarity Index score, the status indicator, a provenance verification status, and a group boost factor; and
display the ranked item records in the mobile application interface with the status indicator, the computed Rarity Index score, and a provenance badge.

2. The system of claim 1, wherein the rarity algorithm utilizes a weighted aggregation formula: Rarity Index=100−[(w₁×normalized listings)+(w₂×normalized wants) (w₃×normalized velocity +(w₄×discontinuation factor)+(provenance bonus)], wherein the weights w₁, w₂, w₃, and w₄ are tuned via a machine learning model trained on historical item data.

3. The system of claim 2, wherein the Rarity Scoring Module further implements a spike detection module configured to monitor changes in the computed Rarity Index score for items tracked by one or more users, and to trigger a push notification alert via the Notification Service when the Rarity Index score of a tracked item changes by a threshold amount of at least 15 points within a defined monitoring period.

4. The system of claim 3, further comprising a blockchain provenance verification module configured to:
receive item information comprising at least one of images, documents, or serial numbers;
extract item attributes via the AI/ML Module and generate a cryptographic hash of the extracted attributes using a SHA-256 algorithm;
deploy a smart contract on a blockchain network to mint a non-fungible token storing the cryptographic hash and associated metadata with decentralized storage of supporting media on IPFS; and
upon a subsequent ownership transfer, automatically execute the smart contract to update the blockchain ledger and distribute a royalty payment to an original seller wallet address.

5. The system of claim 4, wherein the system further comprises a feedback loop architecture in which the Rarity Scoring Module outputs a computed Rarity Index score that is simultaneously transmitted to one or more of the following:
the Dynamic Pricing Module to generate pricing suggestions, the Notification Service to evaluate spike detection thresholds and generate predictive alerts, the Community Bulletin Service to prioritize bidirectional matching of a want posts with seller listings, and the result merge and ranking module of the Search Aggregator to rank search results.

6. The system of claim 5, wherein a change in any input signal to the Rarity Scoring Module propagates through all consuming modules without requiring separate recalculation by each module.

7. The system of claim 6, wherein a mobile application executing on a client device provides a dual-mode initial launch interface comprising: a first mode displaying an initial search page providing quick on-the-go searching capability without requiring full application entry; and a second mode displaying a search prompt in a selectable buyer portion or a seller portion.

8. The system of claim 7, wherein initial launch interface is rendered on a mobile computing device comprising a touchscreen display, a device camera communicatively coupled to the at least one processor, and a wireless communication module.

9. The system of claim 8, wherein a code scanning module accesses the device camera in real-time to capture and decode codes using a processing library selected from one or more of the following: ZXing, ML Kit, and AVFoundation.

10. The system of claim 9, wherein the system further utilizes quantum-inspired processing hardware for processing large dataset queries received by the Search Aggregator from the plurality of external data sources.

11. The system of claim 1, further comprising a blockchain provenance verification module configured to:
receive item information comprising at least one of images, documents, or serial numbers;
extract item attributes via the AI/ML Module and generate a cryptographic hash of the extracted attributes using a SHA-256 algorithm;
deploy a smart contract on a blockchain network to mint a non-fungible token storing the cryptographic hash and associated metadata with decentralized storage of supporting media on IPFS; and
upon a subsequent ownership transfer, automatically execute the smart contract to update the blockchain ledger and distribute a royalty payment to an original seller wallet address.

12. The system of claim 1, wherein a code scanning module accesses the device camera in real-time to capture and decode codes using a processing library selected from one or more of the following: ZXing, ML Kit, and AVFoundation.

13. A computer-implemented method for locating and transacting rare, hard-to-find, or discontinued items, the method comprising:
receiving, at a computing device via a mobile application interface, a search query comprising at least one of a text input, an uploaded image, or extracted code data;
parsing, via a query routing module of a Search Aggregator, the search query to generate a plurality of source-specific queries optimized for respective external data sources;
transmitting each source-specific query to the respective external data source via a corresponding communication protocol;
receiving response data and normalizing, via a data normalization pipeline, the response data into a unified item record scheme;
computing, via a Rarity Scoring Module, a Rarity Index score for each item record using a weighted aggregation formula incorporating active listings count, want post frequency, historical sales velocity, discontinuation factor, and a provenance bonus, wherein the weights are tuned via a machine learning model; and
displaying ranked item records in the mobile application interface with status indicators and the computed Rarity Index score.

14. A non-transitory computer-readable medium storing instructions that, when executed by a processor, cause the processor to perform operations comprising:
providing a mobile application interface for buying, selling, and trading rare, hard-to-find, or discontinued items; executing a multi-source deep search across a plurality of data sources in response to a user search query;
computing a Rarity Index score for each item identified in the search based on weighted metrics including active listings count, want post frequency, historical sales velocity, and discontinuation signals;
displaying search results with status indicators and the computed Rarity Index score; and
generating predictive alerts for items classified as out of stock or discontinued based on machine learning forecasting models analyzing historical patterns, seasonal trends, and restock signals.

15. The non-transitory computer-readable medium of claim 14, wherein computing the Rarity Index score comprises applying a weighted aggregation formula: Rarity Index=100−[(w₁×normalized listings)+(w₂×normalized wants)−(w₃×normalized velocity)+(w₄×discontinuation factor)+(provenance bonus)], wherein the weights w₁, w₂, w₃, and w₄ are tuned via a machine learning model trained on historical item data.

16. The non-transitory computer-readable medium of claim 15, wherein the operations further comprise implementing a spike detection module configured to monitor changes in the computed Rarity Index score for items tracked by one or more users and to trigger a push notification alert via a Notification Service when the Rarity Index score of a tracked item changes by a threshold amount of at least 15 points within a defined monitoring period.

17. The non-transitory computer-readable medium of claim 16, wherein the operations further comprise implementing a feedback loop architecture in which the computed Rarity Index score is simultaneously transmitted to one or more of: a Dynamic Pricing Module to generate pricing suggestions, the Notification Service to evaluate spike detection thresholds and generate predictive alerts, a Community Bulletin Service to prioritize bidirectional matching of Want posts with seller listings, and a result merge and ranking module of a Search Aggregator to rank search results, wherein a change in any input signal to the Rarity Scoring Module propagates through all consuming modules without requiring separate recalculation by each module.

18. The non-transitory computer-readable medium of claim 11, wherein the operations further comprise accessing a device camera to capture and decode at least one of a QR code, a barcode, a UPC code, an EAN code, or a serial number using a processing library selected from one or more of ZXing, ML Kit, and AVFoundation, and either auto-populating item listing fields for a seller or triggering the multi-source deep search for a buyer based on the decoded data.
